(19) United States
(12) Patent Application Publication
(10) Pub. No.: US 2003/0189107 A1
(43) Pub. Date: Oct. 9, 2003

(54) Pull-out kitchen sprayer

(75) Inventor: Orlando Bosio, Casaloldo (IT)

Correspondence Address: MODIANO & ASSOCIATI, Via Meravigli, 16, MILANO, 20123, IT

(73) Assignee: AMFAG S.P.A.

(21) Appl. No.: 10/401,968

(22) Filed: Mar. 31, 2003

(30) Foreign Application Priority Data
Apr. 4, 2002 (IT) MN2002A000014

(51) Int. Cl. B05B 1/32

(52) U.S. Cl. 239/451

(57) ABSTRACT

A pull-out kitchen sprayer, comprising a central body accommodated within an outer enclosure, designed to convey water between an inlet associated with a flexible water feed hose and an outlet disk that comprises a central passage and peripheral passages, and comprising a switching device, and two elements constituted by the central body and by the outlet disk that are provided with arrangements for mutual locking with the interposition of a raised portion that protrudes from the internal surface of the enclosure, to lock the enclosure with respect to the elements.

### BACKGROUND OF THE INVENTION

The invention relates to a pull-out kitchen sprayer.

The great diffusion achieved by so-called kitchen sprayers or shower heads is known; such kitchen sprayers are connected to a flexible hose, so that they can be pulled out of faucets in order to reach distant positions within the sinks, and convey water with the possibility to provide the outflow of the water as a central jet or as a peripheral jet by operating a switching device provided for this purpose.

Said sprayers or shower heads comprise a central body, which is designed to convey the water to an outlet disk, and an outer enclosure, which in sprayers of the background art is required to perform not only the aesthetic functions pertaining thereto but also structural functions by cooperating in the assembly of the individual components of said sprayers.

This leads to the circumstance that the material that constitutes the enclosure of said sprayers is subjected to significant stresses, and this fact is a limitation in the design of the enclosure made of plastics, since materials that are particularly valid from an aesthetic standpoint can be used only with particular adjustments and without always achieving a high degree of safety from the mechanical standpoint.

### SUMMARY OF THE INVENTION

The aim of the present invention is therefore to provide a pull-out kitchen sprayer whose structure is such that it does not entail stresses within the outer enclosure, so as to allow to adopt without particular difficulties any plastic material for the manufacture of said enclosure.

The proposed aim is achieved by a pull-out kitchen sprayer according to the invention, characterized in that the two elements formed by the central body and by the outlet disk are provided with means for mutual locking with the interposition of a raised portion that protrudes from the internal surface of the enclosure, said enclosure being thus locked with respect to said elements.

### BRIEF DESCRIPTION OF THE DRAWINGS

Further characteristics and advantages of the present invention will become better apparent from the description of a preferred but not exclusive embodiment thereof, illustrated only by way of non-limitative example in the accompanying drawings, wherein:

FIG. 1 is a view of the sprayer mounted on a faucet;

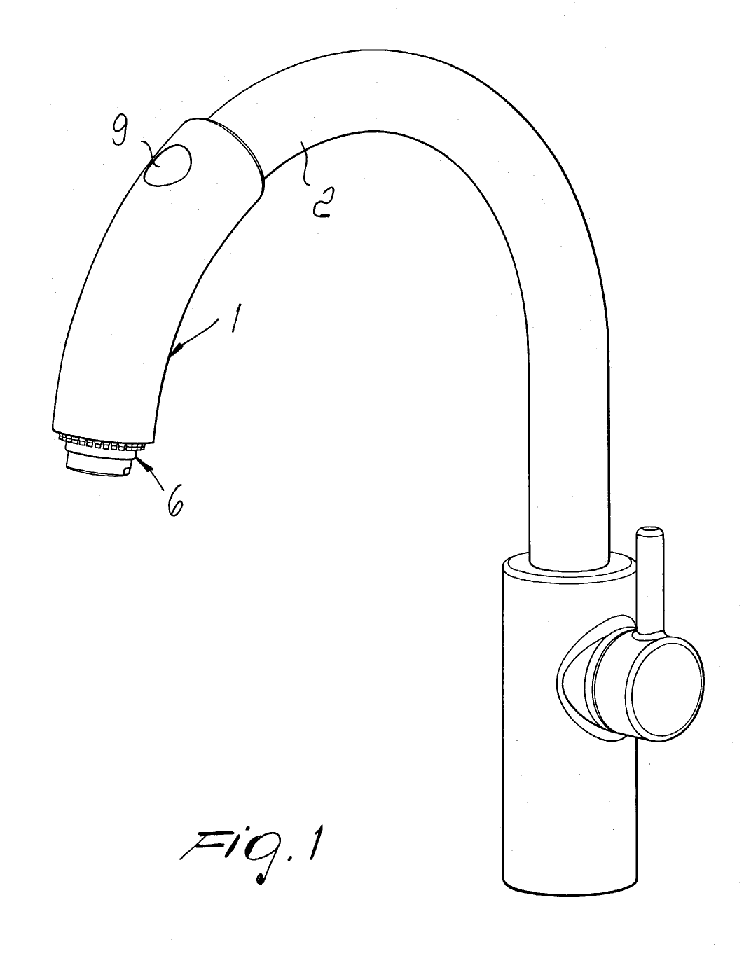

FIG. 2 is a partial sectional view of the sprayer;

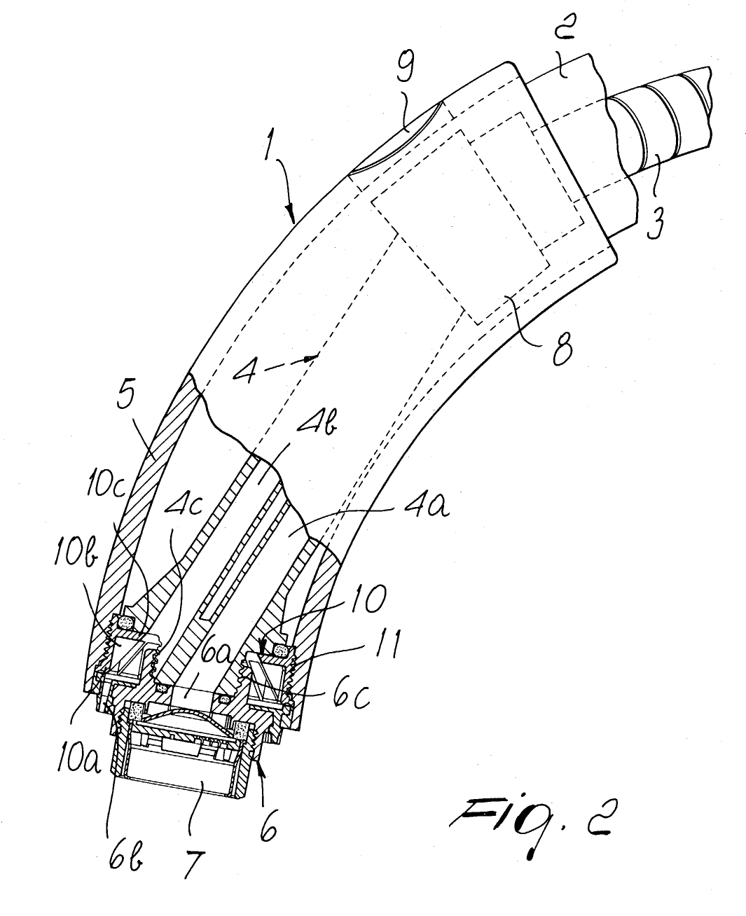

FIG. 3 is an exploded view of the sprayer.

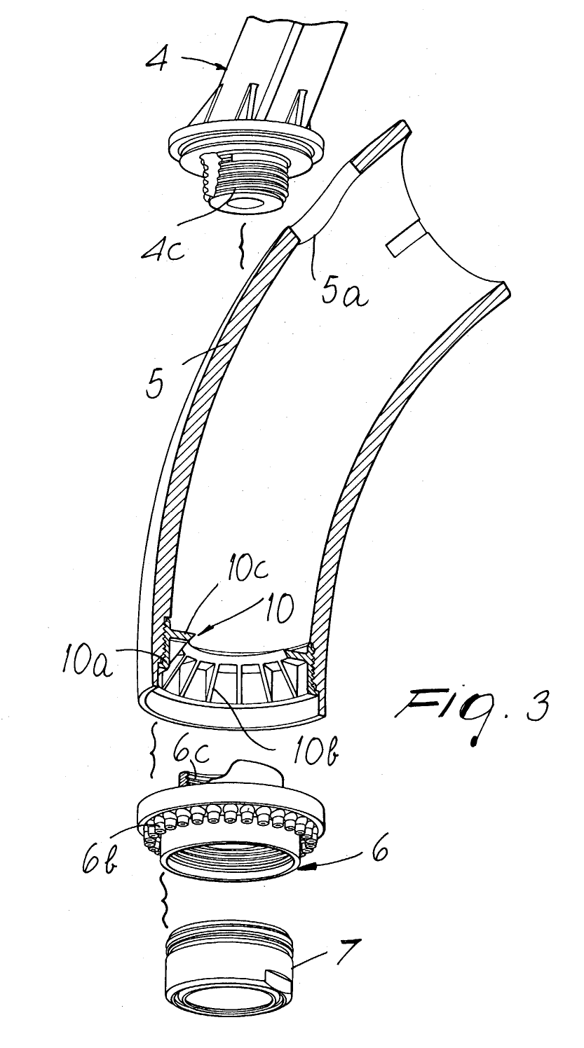

### DESCRIPTION OF THE PREFERRED EMBODIMENTS

With reference to the figures, the reference numeral 1 generally designates the pull-out sprayer or shower head in contact with the tubular body 2 of the faucet that is designed to contain the flexible water feed hose 3.

More specifically, said sprayer comprises the central body 4, which is accommodated within the outer enclosure 5 and is designed to convey the water between an inlet, which is associated with the flexible hose 3, and the outlet disk 6, which comprises the central passage 6a, provided with the assembly constituted by the aerator and the filters 7, and the peripheral passages 6b.

A switching device 8, whose description is not made here, is comprised within the central body 4 and can be accessed by a user by way of the opening 5a of the enclosure, which is provided with an elastic cap 9 in order to provide the access of the water selectively to the duct 4a connected to the central passage 6a and to the duct 4b connected to the peripheral passages 6b.

An important feature of the invention is the fact that the central body 4 and the outlet disk 6 are provided with locking means, such as complementary threads, respectively a male thread 4c and a female thread 6c, for producing mutual locking with the interposition of a raised portion 10 that comprises a ring 10a associated with the enclosure 5 by means of a locking thread 11, with ribs 10b for connection to an annular tab 10c.

The mutual locking of the two elements constituted by the central body 4 and the outlet disk 6 clamps the raised portion 10 between them and consequently locks the enclosure 5 with respect to the sprayer assembly without subjecting the material of said enclosure to any stress.

The raised portion 10 can of course be applied to the enclosure 5 in any manner and can also be provided monolithically with it.

The described invention is susceptible of numerous modifications and variations, all of which are within the scope of the appended claims: thus, for example, the raised portion 10 can be provided as discontinuous segments.

The disclosures in Italian Patent Application No. MN2002A000014 from which this application claims priority are incorporated herein by reference.

What is claimed is:

1. A pull-out kitchen sprayer, comprising: an outer enclosure; a central body accommodated within the outer enclosure, for conveying water between an inlet associated with a flexible water feed hose; an outlet disk that comprises a central passage and peripheral passages connected to respective water ducts; a switching device for providing access for the water selectively to the duct connected to said central passage and to the duct connected to said peripheral passages; a raised portion that protrudes from an internal surface of the enclosure; and locking means for locking with the interposition of the raised portion two elements constituted by the central body and by the outlet disk, said enclosure being thus locked with respect to said two elements.

2. The sprayer of claim 1, wherein locking means for locking said central body and said outlet disk are constituted by complementary threads.

3. The sprayer of claim 1, wherein said raised portion that protrudes from the internal surface of the enclosure extends over an entire perimeter of said internal surface.

4. The sprayer of claim 3, wherein said raised portion is provided applied to said enclosure.

5. The sprayer of claim 4, wherein said raised portion applied to said enclosure is associated thereto by way of a locking thread.

6. The sprayer of claim 3, wherein said raised portion is formed monolithically with said enclosure.
